(19) United States
(12) Patent Application Publication
(10) Pub. No.: US 2011/0019352 A1
(43) Pub. Date: Jan. 27, 2011

(54) RACK-MOUNT COMPUTER

(76) Inventors: Won-Ok KWON, Daejeon (KR); Seong Woon Kim, Daejeon (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/632,711

(22) Filed: Dec. 7, 2009

(30) Foreign Application Priority Data
Jul. 23, 2009 (KR) 10-2009-0067135

(51) Int. Cl. G06F 1/16; G06F 1/26

(52) U.S. Cl. 361/679.02; 713/300

(57) ABSTRACT

A rack-mount computer mounted in a rack system connected to multiple terminals, includes: a power distribution board (PDB) for supplying each power load with DC power; a storage device connected to a backplane for receiving power from the PDB in a hotplug manner; a mainboard for receiving power from the PDB to execute computing; and an input/output card, connected to the mainboard, for processing specific input/output data.

### CROSS-REFERENCE(S) TO RELATED APPLICATION(S)

The present invention claims priority of Korean Patent Application No. 10-2009-0067135, filed on Jul. 23, 2009, which are incorporated herein by reference.

### FIELD OF THE INVENTION

The present invention relates to a centralized computer system, and more particularly, to a rack-mount computer which is adapted to centralize a distributed computing environment.

### BACKGROUND OF THE INVENTION

In recent years, utility computing environments (e.g., public service facilities, call centers, internet cafes, computer rooms in schools, CBT testing sites, etc.) using multiple similar computer systems have grown in number exponentially, and individual computers used in such utility computer environments are run in their respective computer environments. That is, each computer is available for one user in most cases and peripherals, serving as a user interfaces including a monitor, a keyboard, a mouse and so on, are connected to a main body, including a central processing unit (CPU), a memory, a storage device (HDD), a graphic card and a power supply unit. In addition, individual computers may be connected by a network and integratedly managed.

FIG. 1 is a view showing a distributed computer environment connected by a network.

Referring to FIG. 1, each individual computing devices 104, 106, 108, 110 and 112 including a main body, a monitor, a keyboard, a mouse, and so on runs on AC power supplied through a separate power supply unit (PSU) incorporated within the main body, and is connected to a server 102 by a network so that it can be connected to an external network through the server 102 or it can share and send/receive data with other computing devices connected thereto.

The term “computing device” is used herein to include any electronic system designed to perform computation or data storage functions, including but not limited to, an electronic device having a CPU, a computer, a server, a work station or the like.

An administrator computing device 100 monitors and supervises the respective computing devices 104 to 112 connected to the server 102, and performs software upgrade and error recovery by remote control through the network if required.

Although the distributed computer system that operates as described above is able to perform monitoring and remote control through networking in which the respective computing devices are connected by the network, if there is a hardware fault on the main body itself, the administrator has to go to the place where computing devices with the fault are located to perform maintenance. In addition, a large space is inefficiently occupied because each computer is distributed to each person, and power loss is high due to the AC power supply unit installed in each computing device.

### SUMMARY OF THE INVENTION

In view of the above, the present invention provides a rack-mount computer which can centralize computers in a distributed computer environment in a rack, and connect to a DC power source in an available form, instead of a separate AC power supply unit.

Further, the present invention provides a rack-mount computer which can centralize computers in a distributed computer environment in a rack to switch from a separate AC power supply unit to a DC power scheme and enable easy mounting and demounting of a storage device in a front hotplug manner.

Still another object of the present invention is to provide a rack-mount computer which can centralize individual distributed computers in a rack to switch from a separate AC power supply unit to a DC power scheme, easily replace a power supply in the case of an error, and enable easy mounting and demounting of a storage device in a front hotplug manner.

In accordance with an aspect of the present invention, there is provided a rack-mount computer, comprising:

a rack with a 2U height in a rack system, the rack having the rack-mount computer mounted therein;

two power distribution boards (PDBs) for supplying each power load with an applied DC power in voltage based on the ATX power specification;

a backplane for receiving power from the PDBs;

two storage devices connected to the backplane in a front hotplug manner;

two mainboards, consecutively disposed in the rack in a longitudinal direction and connected to receive power from the PDBs, for executing computing tasks; and

two input/output cards, connected to the two mainboards, respectively, for processing specific input/output data.

In accordance with another aspect of the present invention, there is provided a rack-mount computer mounted in a rack system connected to multiple terminals, comprising:

a power distribution board (PDB) for supplying each power load with DC power;

a storage device connected to a backplane for receiving power from the PDB in a hotplug manner;

a mainboard for receiving power from the PDB to execute computing; and

an input/output card, connected to the mainboard, for processing specific input/output data.

According to the rack-mount computer in accordance with the embodiment of the present invention, a plurality of computers can be centralized in a rack-mount computer structure, thereby innovatively reducing the space where respective computers are distributed and occupied by them and realizing a slim structure for mounting one computer in a 1U space.

Moreover, a rack-mount chassis structure, compatible with existing ATX, Micro-ATX, and graphic card form factors, can be implemented, it is easy to mount and demount a storage device and a power supply unit to make it convenient for computer maintenance, and the input of DC power is supported so that power can be saved and heat generation can be considerably reduced.

### BRIEF DESCRIPTION OF THE DRAWINGS

The above and other objects and features of the present invention will become apparent from the following description of embodiments, given in conjunction with the accompanying drawings, in which:

FIG. 1 is a view showing a distributed computer environment connected by a network;

FIG. 2 is a view showing a centralized computing structure in accordance with an embodiment of the present invention;

FIGS. 3A to 3C are views showing a structure, a signal timing chart, and an implementation of a power supply in accordance with the embodiment of the present invention, respectively;

FIGS. 4A and 4B show plan views of different structures of a rack-mounted 1U 1(one)-computer in accordance with the embodiment of the present invention;

FIGS. 4C and 4D shows a rear and a front view of the structure of a rack-mounted 1U 1(one)-computer shown in FIGS. 4A and 4B, respectively;

FIG. 4E shows a flexible cable in the form of a PCI Express 16x flexible cable;

FIG. 5A is a view showing a structure of a rack-mounted 2U 2(two)-computer in accordance with the embodiment of the present invention;

FIG. 5B is a front surface of the 2U rack shown in FIG. 5A;

FIG. 5C is a rear surface of the 2U rack shown in FIG. 5A;

FIG. 5D is a view showing an integrated KVM connector in accordance with the embodiment of the present invention;

FIG. 5E shows an extension cable 552 such as an RJ45 Extension Cable;

FIG. 6A is a view showing a structure of a rack-mounted 3U 3(three)-computer in accordance with the embodiment of the present invention;

FIG. 6B is a front surface of the 3U rack shown in FIG. 6A;

FIG. 6C is a rear surface of the 3U rack shown in FIG. 6A;

FIG. 7A is a view showing a structure of a rack-mounted 3U 4 computer in accordance with the embodiment of the present invention;

FIG. 7B is a rear surface of the 3U rack shown in FIG. 7A; and

FIG. 7C is a perspective view of the 3U rack shown in FIG. 7A.

### DETAILED DESCRIPTION OF THE EMBODIMENT

The above and other advantages and features of the present invention and methods of accomplishing these will be clearly understood from the following embodiments taken in conjunction with the accompanying drawings. However, the present invention is not limited to those embodiments but may be implemented in various forms. It should be noted that the present embodiments are provided to make a full disclosure of the invention and also to allow those skilled in the art to know the full range of the invention. Therefore, the present invention is to be defined only by the scope of the appended claims. Further, like reference numerals identify like or similar elements throughout the specification.

Hereinafter, embodiments of the present invention will be described in detail with the accompanying drawings.

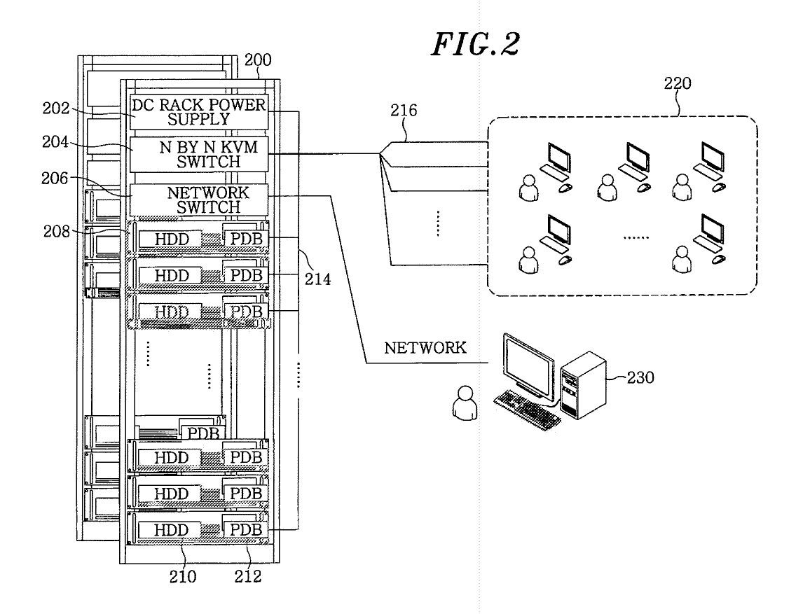

FIG. 2 is a view showing a centralized computing structure in accordance with an embodiment of the present invention.

Referring to FIG. 2, the centralized computer structure generally includes a rack system 200, multiple terminals 220, and a management device 230. The rack system 200 includes a DC rack power supply 202, an N×N KVM (keyboard, mouse and monitor) switch 204, a network switch 206, and multiple computers 208, where N is a positive integer. The DC rack power supply 202 receives AC power, converts it into multiple DC powers, and provides them to DC output ports. The DC powers provided to the DC power ports are supplied to respective computers 208 through DC cables 214.

The N×N KVM switch 204 is a terminal connection switch, which receives a KVM signal from the respective computers 208 mounted on the rack system 200 and delivers it to the terminal 220 through KVM cables 216. For example, when there are N terminals and N computers, the N×N KVM switch 204 may have N inputs and N outputs. Here, KVM is abbreviation for keyboard, video and mouse, but is not limited thereto, a speaker, microphone and USB port may also be included in addition to the keyboard, video and mouse port.

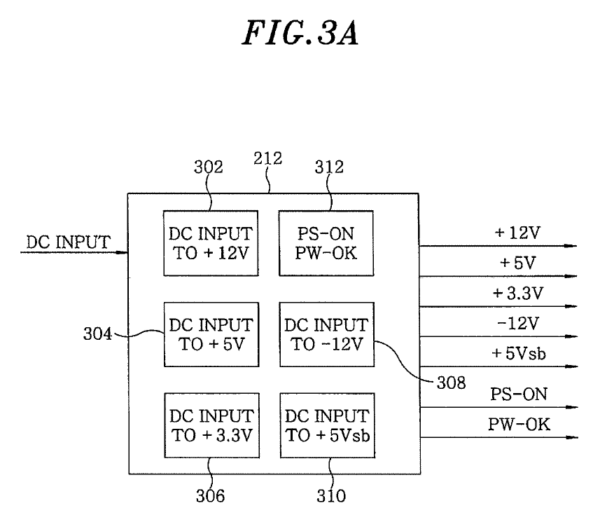

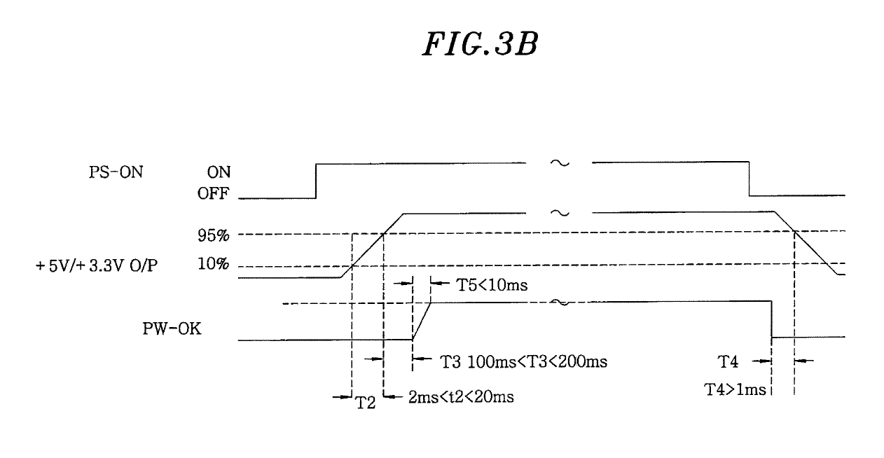

Each of the computers 208 incorporate a front hotplug type of storage devices 210 (e.g., hard discs (HDDs) or solid state drives (SSDs)), thus making fault recovery and movement easier. Also, each computer 208 is provided with a power distribution board (PDB) 212 which receives a DC power from the DC rack power supply 202 and supplies it to each power load therein. The computer 208 of this type mounted on the rack system 200 has a structure in which a mainboard, a graphic card, a power supply unit, etc. of a general computer can be easily mounted. The computer 208 is mounted in a standard 19-inch rack (e.g., 19 inches width×2.2 m height×0.9 m depth) or in a separate standard rack. A concrete description thereof will be described later with reference to FIGS. 3A to 7C.

The management device 230 is remotely connected to the rack system 100 through the network switch 206 via network, remotely performs monitoring and control of the operation of the rack system 200, and remotely controls the N×N KVM switch 204 through N×N KVM switch management software, to thereby check and change a connection state between the terminals 220 and the computers 208. In addition, the management device 230 monitors whether there is a problem with power of the DC rack power supply 202, and performs power control for each computer 208 based on the N×N KVM switch management software. If an advanced configuration and power interface (ACPI) power management agent is installed in each computer 208, the management device 230 can establish an ACPI policy for the computer 208 through ACPI management software and execute a power saving mode on the terminals 220 depending on the established ACPI policy.

Therefore, it is possible to remotely supervise and control the terminals 220 through the rack system 200 and the management device 230. Only user interface devices, such as a monitor, a keyboard, a mouse, a speaker, a microphone, a USB port, and the like are installed on the terminals 220, thereby enabling efficient space utilization.

FIGS. 3A to 3C are views showing a structure, a signal timing chart, and an implementation example of a power supply in accordance with the embodiment of the present invention, respectively.

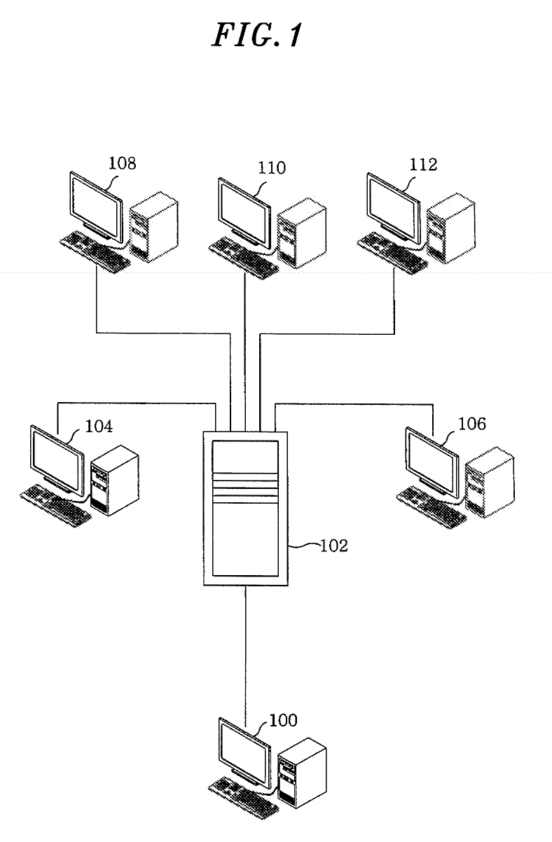

Referring to FIG. 3A, the PDB 212 to be mounted on the rack system of FIG. 1 is a device which supplies a DC input to a power source compatible with the ATX (Advanced Technology Extended) power specification used in computer mainboards. The PDB 212 is supplied with a DC power of 12V to several hundred volts (V). The PDB 212 includes DC-to-DC converters 302, 304, 306, 308 and 310, a PS-ON and PW-OK generator 312 to provide a variety of powers of +12V, +5V, +3.3V, −12V and +5V sb (stanby), a power supply-ON signal (PS-ON), and a power-OK signal (PW-OK).

FIG. 3B shows timing for generating a PW-OK signal. When a DC voltage is applied to the PDB 212, PS-ON changes from 0 to 1; and when 95% or more of powers of +3.3V and +5V are normally outputted through the DC to DC conversion, a PW-OK signal is generated. The timing of a control signal is designed to comply with the ATX power specification.

FIG. 3C is a block diagram of the PDB 212 to which a 12V-input is applied. A first step-down converter 350 receives a DC 12V input and generates +5 Vsb power. This +5 Vsb power is used as a standby power source and allows a maximum of 4 A current. Second and third step-down converter 356 and 358 are connected to the DC switch part 352 to generate +5V and +3.3V, respectively.

A DC switch part 352 serves to selectively deliver or interrupt the DC 12V input to loads, e.g., the second and third step-down converters 356 and 358 connected thereto. The control therefor is carried out by a voltage supervisor 354. The voltage supervisor 354 generates a PW-OK signal so as to deliver the DC 12V input through the DC switch part 352 if +5V and +3.3V normally operate and interrupt the DC 12V input through the DC switch part 352 if OV (overvoltage) or UV (undervoltage) is generated.

This embodiment employs the input voltage of +12V and generates +3.3V and +5V through the use of the second and third step-down converters 356 and 358. Although it has not been shown and described the generation of −12V in this embodiment, −12V may be generated by a −12V generator if required. This embodiment is related to a case of 12V input, and even in the case of an input voltage other than 12V, ATX compatible powers and signals are generated in the same manner as above. As the PDB 212 is only in charge of DC-to-DC conversion unlike AC PSU, it can be designed into a considerably small form factor with a board size of 10 cm×10 cm or less.

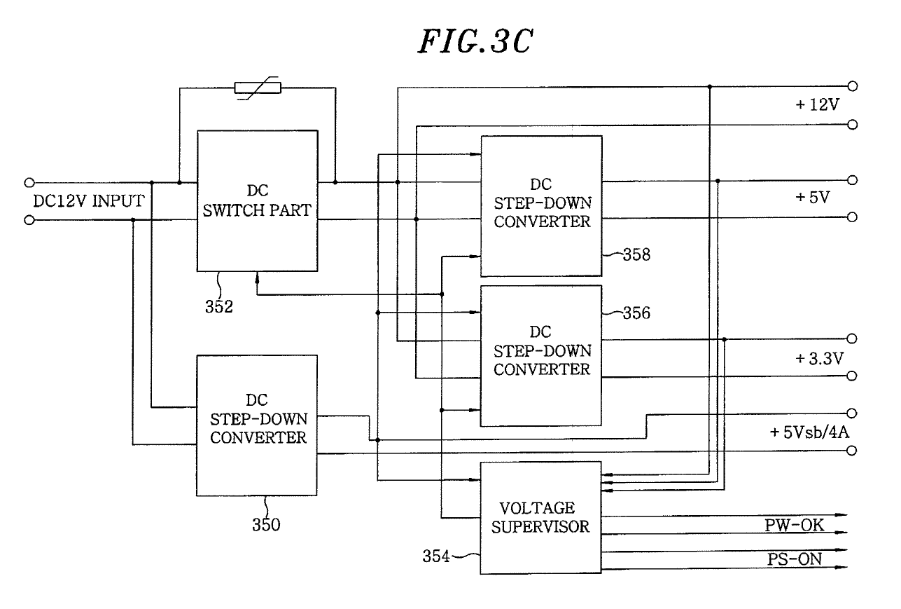

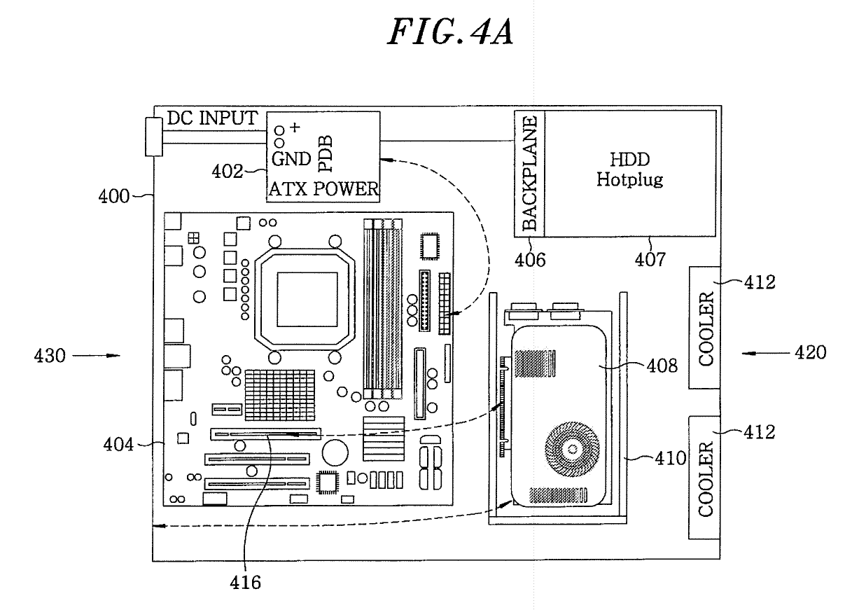

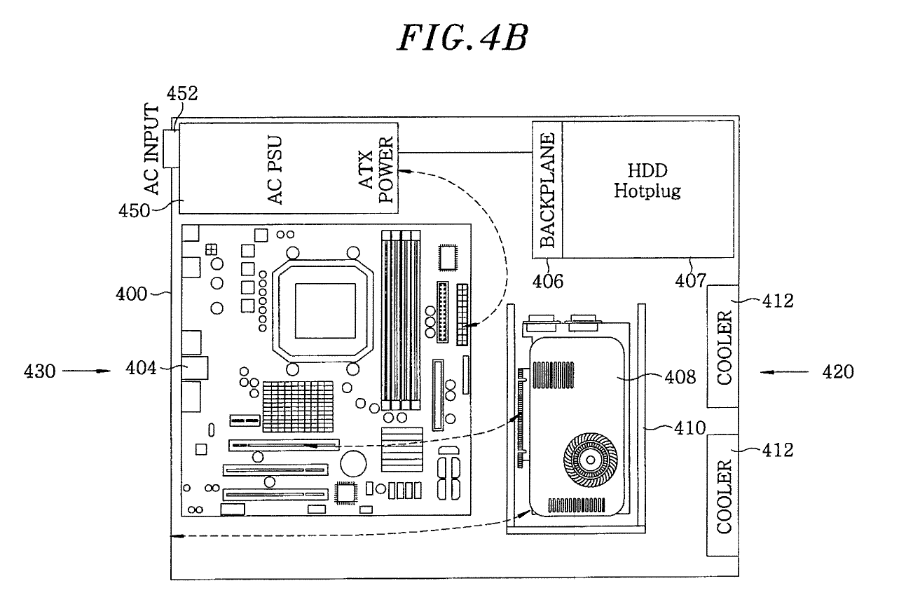

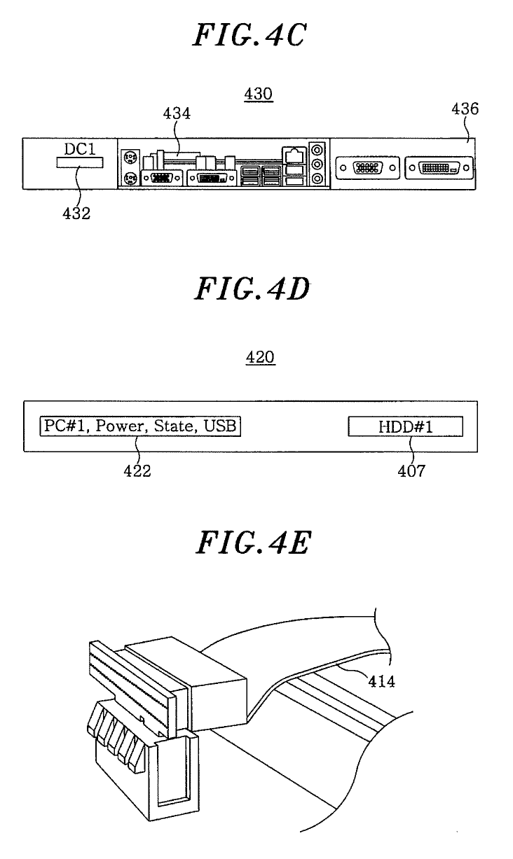

A computer structure mountable in each rack will be described below in detail with reference to FIG. 4A to FIG. 7C.

Since a commercial computer occupies a space of 3U or more in height, there may be a problem with the mounting of other peripheral cards, including I/O cards, for example, graphic cards, sound cards, etc., when mounting the computer in a rack of 1U (approximately 44 mm). Thus, a solution thereof is required.

A 19-inch rack-mount server is in common currency 42 to 45 cm in the horizontal length, but is set to 44 cm in the embodiment of the present invention. However, such a horizontal length may be varied in racks other than a 19-inch standard rack. The longitudinal length thereof should be generally 1 m or less so as to mount the computing devices on the rack. Likewise, the longitudinal length may also be varied in the case of racks other than the standard rack.

Also, the specifications of a mainboard mounted in a commercially available computer include ATX (305×244 mm), Micro-ATX (244×244 mm), Micro-ATX mini (171×171 mm), and Mini-ITX (170×170 mm). The ATX specifications are widely used in the PC market and support a large number of I/O slots including PCI, PCI Express, etc. For Micro-ATX, with a trend toward integrating most of the functions on a mainboard, a decreased width of the ATX with a reduced number of I/O slots is widely used. Most of the specifications of Micro-ATX Mini and Mini-ITX cannot support commercial graphic cards even if I/O slots support only PCI or both PCI and PCI Express. Therefore, Micro-ATX with good compatibility and small form factor is suitable as a PC mainboard of a rack-mount type although ATX, too, may be an option.

FIGS. 4A and 4B show plan views of different structures of a rack-mounted 1U 1(one)-computer in accordance with the embodiment of the present invention. FIGS. 4C and 4D show a rear surface and a front surface of the structure of a rack-mounted 1U 1-computer shown in FIGS. 4A and 4B, respectively.

According to the present invention, as shown in FIG. 4A, in case of manufacturing a rack-mounted computer structure having a 1U height, the horizontal length of the rack 400 is defined to be 43 cm and the longitudinal length thereof is defined to be 40 to 60 cm. It is understood that the defined lengths are variable based on an implementation of this embodiment.

A PDB 402 is disposed as a power supply unit to be mounted in the 1U rack 400, and the PDB 402 supplies ATX power to a mainboard 404, a HDD backplane 406, a cooler 412, and so on. The mainboard 404 includes mainboards of ATX mainboard, Micro-ATX mainboard, or other forms. In case of a CPU cooler (not shown), only a 1U cooler can be used.

Further, in case of inserting an I/O card in the mainboard 404, a raiser card type should be used. As a graphic card 408, PCI Express 16x, which is commercially available, can be used, and other connection types compatible with the graphic card 408 may also be used. However, it is impossible to mount the graphic card 408 on a raiser card after mounting the raiser card on the mainboard due to a mechanical problem with the 1U height. Therefore, as shown in FIG. 4A, a flexible cable 414 connected from the graphic card 408 in the form of a PCI Express 16x flexible cable as shown in FIG. 4E is connected to the slot 416 of the mainboard 404. Further, a mechanical support 410 may be employed for mounting the graphic card 408 on the mainboard 404. The cooler 412 may be disposed at an appropriate position for smoothly cooling down the CPU and the graphic card 408, but is preferably installed at the rear within the 1U rack 400. The HDD 407 supports a front hotplug feature, thereby enabling quick replacement of the HDD 407 in the event of failure.

As shown in FIGS. 4C and 4D, if the graphic card 408 is to be connected in the form of the flexible cable 414, an extension cable is used to connect a graphics output connector to the rear surface 430 of the 1U rack 400. The extension cable may be a DSUB (D-subminiature) analog output connector or a digital connector such as DVI (Digital Video Interactive). Here, an integrated terminal 422, including a power button, a state flashing light (e.g., LED), and a USB port, can be positioned on the front surface 420 of the 1U rack 400. In addition, a DC input port (DC1) 432, mainboard connectors 434, and a graphic card connection port 436 may be positioned on the rear surface 430, and a cooler may be additionally positioned thereon.

On the other hand, as shown in FIG. 4B, if no DC input is used in the 1U rack 400, the PDB 402 is replaced with an AC PSU 450, and the 1U rack 400 supports an AC input terminal 452 at the rear thereof.

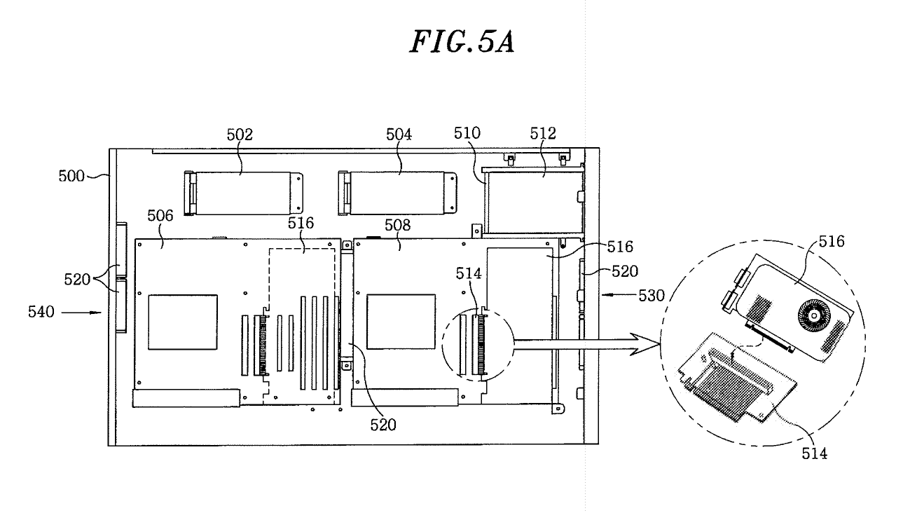

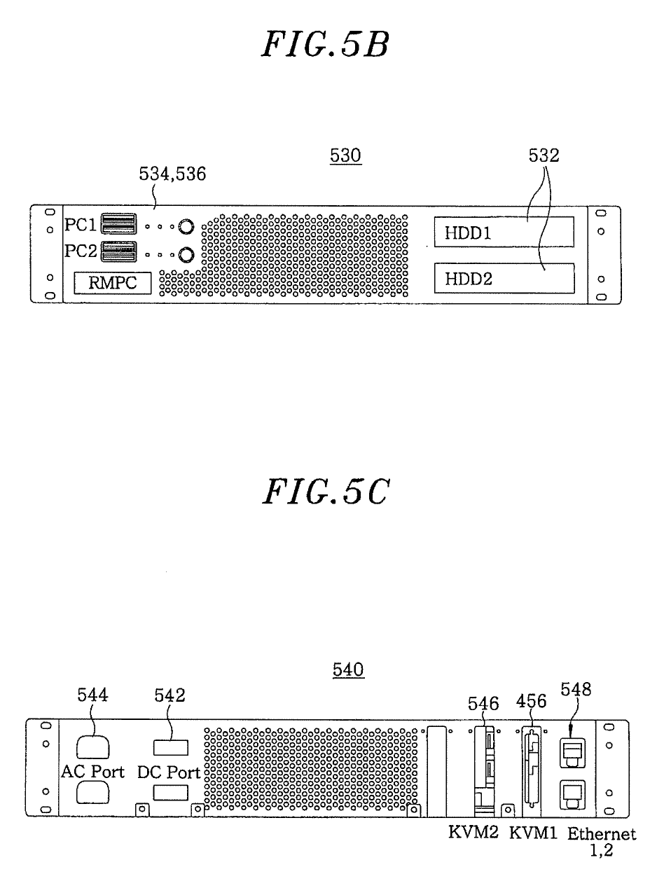

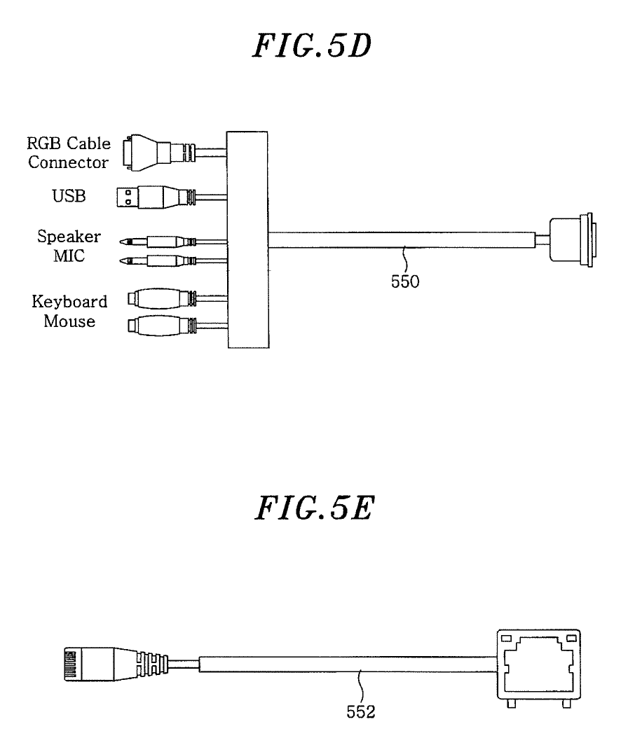

FIG. 5A is a view showing a structure of a rack-mounted 2U 2(two)-computer in accordance with the embodiment of the present invention; FIG. 5B is a front surface of the 2U rack shown in FIG. 5A; FIG. 5C is a rear surface of the 2U rack shown in FIG. 5A; and FIG. 5D is a view showing an integrated KVM connector in accordance with the embodiment of the present invention.

According to the present invention, as shown in FIG. 5A, in case of manufacturing a structure for mounting two computers in a 2U rack 500 with a 2U height, the horizontal length of the rack 500 is defined to be 43 cm and the longitudinal length thereof is defined to be 70 to 80 cm. It is understood that the defined lengths are variable based on an implementation of this embodiment.

Two mainboards 506 and 508 are consecutively disposed in the 2U rack 500 in a longitudinal direction. Two PDBs 502 and 504 supply power to their respective mainboards 506 and 508 and a HDD 512. A typical CPU cooler, which has been commercialized, is mountable at a 2U height. A graphic card 516, such as an I/O card, is mountable through a raiser card 514 at a 2U height unlike 1U height. Therefore, as shown in FIG. 5A, one graphic card 516 is mounted on one PCI Express raiser card 514, and each raiser card 514 is then mounted on each of the mainboards 506 and 508. Also, a mechanical support 518 may be installed in order to support the graphic card 516. One HDD 512 is connected to each of the mainboards 506 and 508 and supports the front hotplug. A cooler 520 for cooling purpose may be disposed on an appropriate one of the front, side, and rear surface within the 2U rack 500, but is preferably disposed on a side surface or front surface within the 2U rack 500.

Further, as shown in FIG. 5B, the front surface 530 of the 2U rack 500 supports two HDD hotplugs (HDD1 and HDD2) 532, and is provided with a power button (not explicitly shown), a state LED display 534, and a USB port 536 for each computer.

As the two mainboards 506 and 508 are mounted in the 2U rack 500, input/output connectors 546 and 548 (KVM, keyboard, video, mouse, speaker, microphone, USB, and Ethernet) of the mainboards 506 and 508 are disposed on the rear surface 540 of the 2U rack 500 in the form of integrated connector terminals as shown in FIG. 5C. In addition, two DC input connectors 542 and 544 are disposed on the rear surface 540 of the 2U rack 500, and two pairs of integrated KVM connectors 546 and Ethernet connectors 548 are provided on the 2U rack 500. Especially, the Ethernet connectors 548 may be connected to the network switch 206 of FIG. 2, and the integrated KVM connector 546 may be connected to the N×N KVM switch 204 or other computing devices. Further, as shown in FIGS. 5D and 5E, the integrated KVM connector 550 may be a connector having a keyboard, a video, a mouse, a microphone, a USB port, a KVM, etc. integrated therein, and an Ethernet network extends to the rear connector 548 inside the computer through an extension cable 552 such as an RJ45 Extension Cable.

On the other hand, if no DC input is used in the 2U rack 500, the PDBs 502 and 504 may be replaced with an AC PSU, and the 2U rack 500 supports an AC input terminal for the AC PSU at the rear thereof.

Moreover, if it is not desired to mount a raiser card on the graphic card in the structure of the 2U rack 500 shown in FIG. 5A, a 3U rack 2PC structure may be recommended in which two computers can be installed at a 3U height. The 3U rack 2PC structure has the same layout as a 2U 2PC except that only the height thereof increases by 1U. Because the height of a typical graphic card is less than 3U, the graphic card 516, which used to be mounted to the raiser card 514, can be used by being directly plugged to the mainboards 506 and 508.

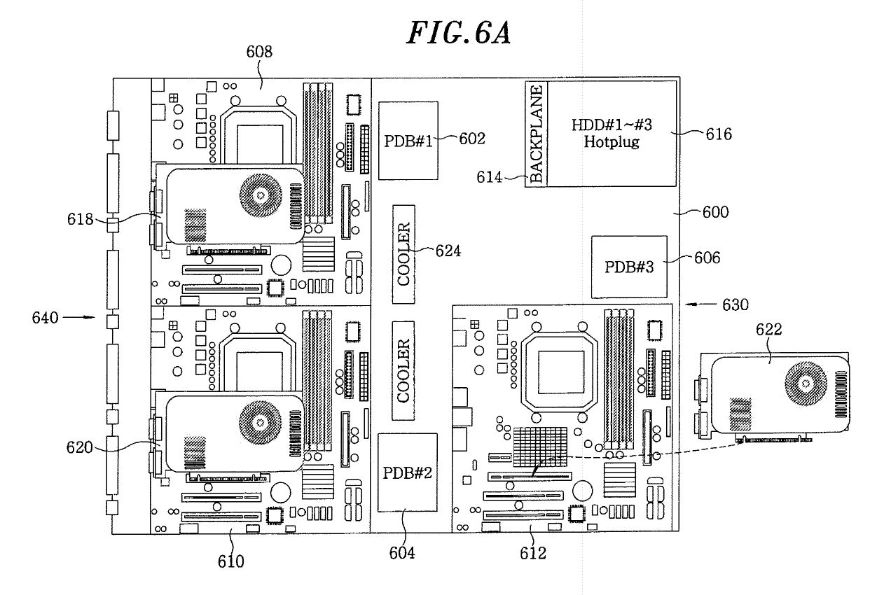

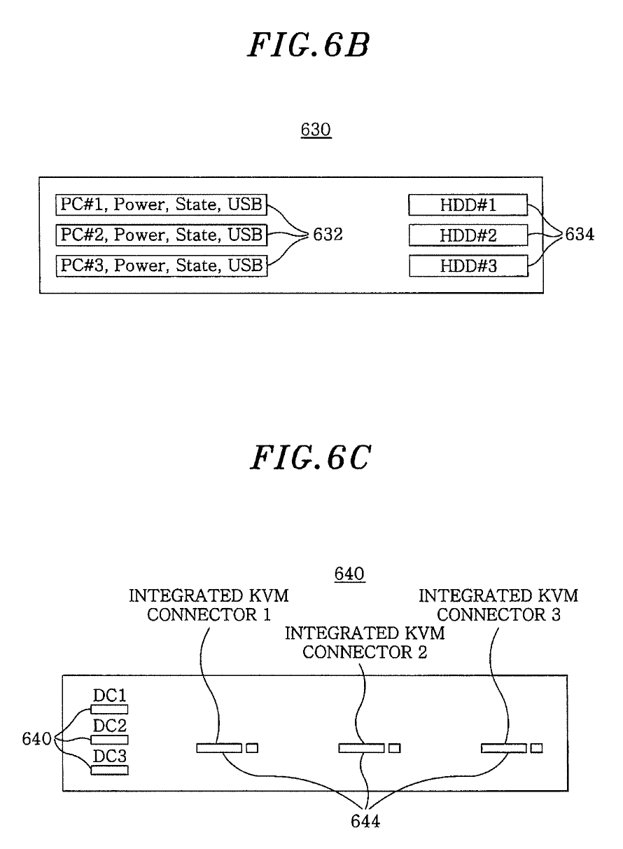

FIG. 6A is a view showing a structure of a rack-mounted 3U 3(three)-computer in accordance with the embodiment of the present invention; FIG. 6B is a front surface of the 3U rack shown in FIG. 6A; and FIG. 6C is a rear surface of the 3U rack shown in FIG. 6A.

According to the present invention, as shown in FIG. 6A, in case of manufacturing a structure for mounting three computers in a 3U rack 600 with a 3U height, the longitudinal length of the 3U rack 600 is defined to be 70 to 80 cm and the horizontal length thereof is defined to be 50 cm. It is understood that the defined lengths are variable based on an implementation of the present invention.

Here, because the height of the 3U rack 600 is large, i.e., 3U, graphic cards 618, 620, and 622 can be used by being directly plugged to mainboards 608, 610, and 612 without a raiser card. However, in order to dispose three mainboards 608, 610, and 612, the minimum horizontal length required is 2 times the minimum ATX length. That is, 492 mm (=244 mm×2) is required. In other words, the minimum horizontal length required is 50 cm or greater in consideration of margin between two adjacent mainboards. Thus, it is difficult to mount three computers in a standard 19-inch rack, but can be used only in a dedicated rack manufactured specially for the embodiment of the present invention. In order to mount three mainboards on the 3U rack 600, the two mainboards 608 and 610 are longitudinally disposed side by side, and the one remaining mainboard 612 is horizontally disposed so as to be consecutive to one of the other two mainboards 608 and 610.

Three PDBs 602, 604 and 606 supply power to their respective mainboards 608, 610 and 612, respectively, and a HDD backplane 614. A typical CPU cooler is mountable at a 3U height; and the graphic cards 618, 620 and 622, such as an I/O card, are mountable directly on their respective mainboards 608, 610 and 612, respectively, without a raiser card.

One HDD 616 is connected to each of the mainboards 608, 610 and 612, and supports the front hotplug. A cooler 624 for cooling purpose may be disposed throughout the 3U rack 600, but is preferably disposed at the center within of the 3U rack 600.

As shown in FIG. 6B, a front surface 630 of the 3U rack 600 supports three HDD hotplugs 634, and provides a set of power button, state LED and USB port 632 for each computer. Three DC input ports 642 and an integrated KVM connector 644 for connecting to three integrated KVM cables and a network port are disposed on a rear surface 640 of the 3U rack 600, as shown in FIG. 3C.

On the other hand, if no DC input is used in the 3U rack 600, the PDBs 602, 604, and 606 can be replaced with an AC PSU, and the 3U rack 600 may support an AC input terminal at the rear surface 640 thereof.

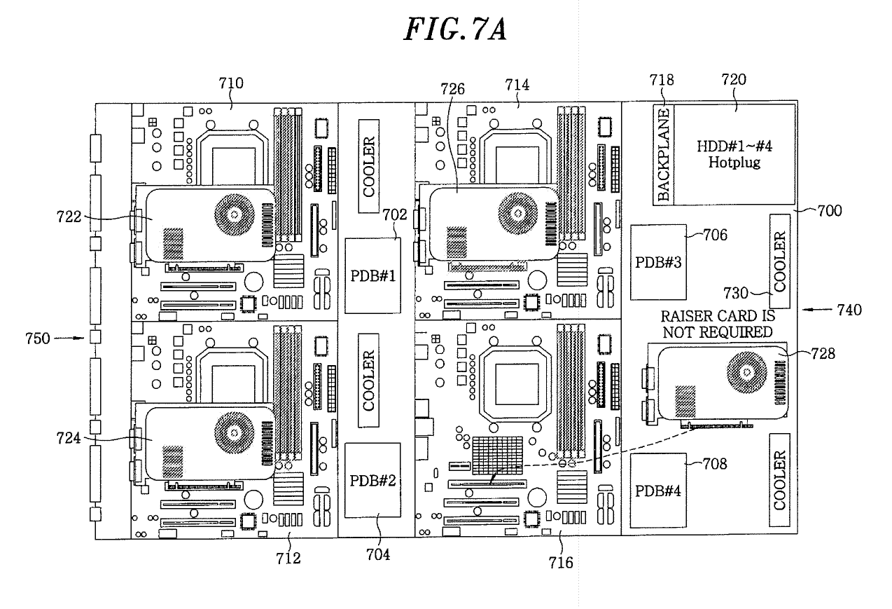

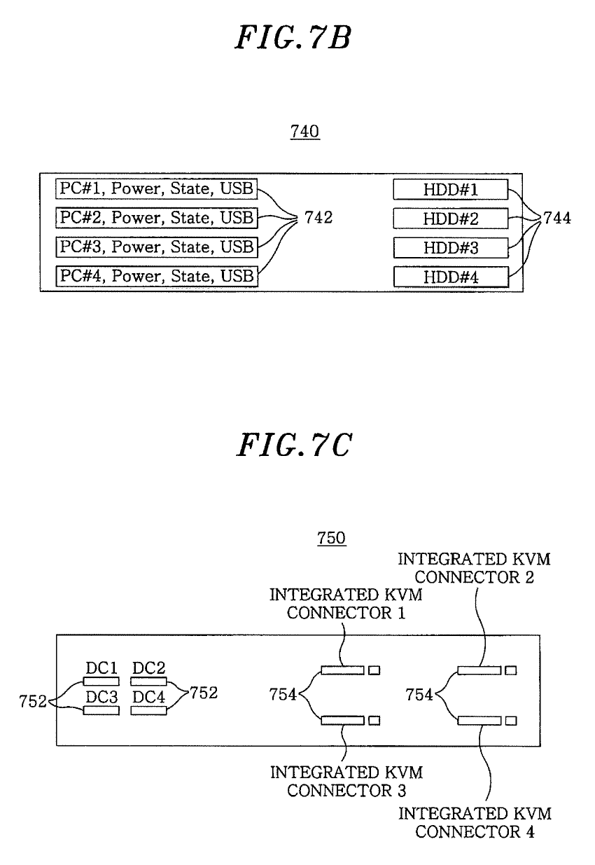

FIG. 7A is a view showing a structure of a rack-mounted 3U 4 computer in accordance with the embodiment of the present invention.

According to the present invention, as shown in FIG. 7A, in case of manufacturing a structure for mounting four computers in a rack 700 with a 3U height, the horizontal length of the 3U rack 700 is defined to be 50 cm and the longitudinal length thereof is defined to be 90 to 110 cm. It is understood that the defined lengths are variable based on an implementation of the present invention.

Because the height of the 3U rack 700 is large, i.e., 3U, graphic cards 722, 724, 726 and 728 can be used by being directly plugged to mainboards 710, 712, 714, and 716 without a raiser card. However, in order to dispose the four mainboards, the minimum horizontal length required is 2 times the minimum ATX length. That is, 244 mm×2=492 mm is required. In other words, the minimum horizontal length required is 50 cm or greater, and the minimum longitudinal length required is 90 cm or greater because four PC boards need to be disposed unlike FIG. 6A. Thus, it is difficult to mount computers in a standard 19-inch rack, but can be used only in a rack manufactured specially for the embodiment of the present invention.

On this 3U rack 700, the four mainboards 710, 712, 714, and 716 are horizontally disposed in two consecutive rows. Four PDBs 702, 704, 706 and 708 supply power to their respective mainboards 710, 712, 714 and 716, and a HDD backplane 718; and may be disposed in front of their respective mainboards 710, 712, 714, and 716.

Also, a typical CPU cooler is mountable at a 3U height, and the graphic cards 722, 724, 726 and 728, such as an I/O card, are mountable directly on their respective mainboards 710, 712, 714 and 716 without a raiser card.

One HDD 720 is connected to each of the mainboards 710, 712, 714 and 716, and supports the front hotplug. A cooler 730 for cooling purpose may be disposed throughout the 3U rack 700, but is preferably installed in front of their respective mainboards 710, 712, 714 and 716 and at a front surface 740 of the 3U rack 700.

As shown in FIG. 7B, the front surface 740 of the 3U rack 700 supports four HDD hotplugs 744, and provides a set of power button, state LED and USB port 742 for each computer. Four DC input ports 752 and an integrated KVM connector 754 for connecting to four integrated KVM cables and a network port are disposed on a rear surface 750 of the 3U rack 700, as shown in FIG. 7C.

On the other hand, if no DC input is used in the 3U rack 700, the PDBs 702, 704, 706 and 708 can be replaced with an AC PSU, the 3U rack 700 may support an AC input terminal at the rear surface 750 thereof.

As described above, therefore, the rack-mounted computer in accordance with the embodiment of the present invention centralizes individual distributed computers in a rack, easily replace a power supply in the case of an error, and enable easy mounting and demounting of a storage device in a front hotplug manner.

While the invention has been shown and described with respect to the embodiments, it will be understood by those skilled in the art that various changes and modification may be made without departing from the scope of the present invention as defined in the following claims.

What is claimed is:

1. A rack-mount computer, comprising:
a rack with a 2U height in a rack system, the rack having the rack-mount computer mounted therein;
two power distribution boards (PDBs) for supplying each power load with an applied DC power in voltage based on the ATX power specification;
a backplane for receiving power from the PDBs;
two storage devices connected to the backplane in a front hotplug manner;
two mainboards, consecutively disposed in the rack in a longitudinal direction and connected to receive power from the PDBs, for executing computing tasks; and
two input/output cards, connected to the two mainboards, respectively, for processing specific input/output data.

2. The rack-mount computer of claim 1, wherein the PDBs each include:
a first step-down converter for receiving the DC power to generate a first power;
a switch part for selectively delivering or interrupting the supply of the DC power to a load;
a second step-down converter for receiving the DC power from the switch part to generate a second power;
a third step-down converter for receiving the DC power from the switch part to generate a third power; and
a voltage supervisor, when the second and third powers are normally outputted from the second and third step-down converters, for generating a power signal (PW-OK) and, when an overvoltage or undervoltage is occurred in the DC power provided to the switch part, for interrupting the supply of the DC power through the switch part.

3. The rack-mount computer of claim 1, wherein each of the mainboards is an ATX board or Micro-ATX board.

4. The rack-mount computer of claim 1, wherein the rack has a horizontal length of 42 to 44 cm and a longitudinal length of 70 to 80 cm.

5. The rack-mount computer of claim 1, further comprising integrated connector terminals for integrating signals to and from the mainboards disposed on the front surface of the rack.

6. The rack-mount computer of claim 5, wherein the integrated connectors include at least one of KVM, video, keyboard, mouse, speaker and Ethernet terminal, and a USB port.

7. The rack-mount computer of claim 1, further comprising an input/output card to be mounted in the rack, wherein the input/output card is connected to slots of the mainboards, while being mounted on a raiser card.

8. The rack-mount computer of claim 7, wherein the input/output card is a graphic card.

9. The rack-mount computer of claim 1, wherein, if the rack system receives AC power, an AC power supply unit (PSU) is mounted instead of the PDBs.

10. A rack-mount computer mounted in a rack system connected to multiple terminals, comprising:
a power distribution board (PDB) for supplying each power load with DC power;
a storage device connected to a backplane for receiving power from the PDB in a hotplug manner;
a mainboard for receiving power from the PDB to execute computing; and
an input/output card, connected to the mainboard, for processing specific input/output data.

11. The rack-mount computer of claim 10, wherein each of the PDB supplies the DC power based on the ATX power specification.

12. The rack-mount computer of claim 10, wherein the PDB includes:
a first step-down converter for receiving the DC power to generate a first power;
a switch part for selectively delivering or interrupting the supply of the DC power to the power load;
a second step-down converter for receiving the DC power from the switch part to generate a second power;
a third step-down converter for receiving the DC power from the switch part to generate a third power; and
a voltage supervisor for, when the second and third powers are normally outputted from the second and third step-down converters, generating a power signal (PW-OK) and, when an overvoltage or undervoltage is occurred in the DC power provided to the switch part, interrupting the input through the switch part.

13. The rack-mount computer of claim 10, wherein the terminals are connected to an integrated connector for integrating signals inputted to and outputted from the mainboard

14. The rack-mount computer of claim 13, wherein the integrated connector includes at least one of KVM, video, keyboard, mouse, speaker and Ethernet terminal, and a USB port.

15. The rack-mount computer of claim 10, wherein the rack has 19 inches wide×1U height.

16. The rack-mount computer of claim 10, further comprising an input/output card mounted in the rack, wherein the input/output card is and connected to the mainboard through a flexible cable.

17. The rack-mount computer of claim 16, wherein the input/output card is a graphic card.

18. The rack-mount computer of claim 10, wherein, if the rack system receives AC power, an AC power supply unit (PSU) is mounted instead of the PDB.

19. The rack-mount computer of claim 10, wherein the rack has a 3U height;
two mainboards are longitudinally disposed and another mainboard is horizontally disposed so as to be consecutive to one of the other mainboards;
three graphic cards are mounted directly on the slots of the respective mainboards and connected to three PDBs and a storage device;
a hotplug storage device and power buttons, state flashing lights, and USB ports of the respective mainboards are disposed on the front surface of the rack; and
power input ports of the PDBs and an integrated connector port for integrating and inputting/outputting input/output signals of the respective mainboards are disposed on the rear surface of the rack.

20. The rack-mount computer of claim 10, wherein the rack has a 3U height;
four mainboards are horizontally disposed in two rows,
four graphic cards are mounted directly on the slots of the respective mainboards and connected to four PDBs and a storage device;
a hotplug storage device and power buttons, state flashing lights, and USB ports of the respective mainboards are disposed on the front surface of the rack; and
power input ports of the PDBs and an integrated connector port for integrating and inputting/outputting input/output signals of the respective mainboards are disposed on the rear surface of the rack.
